(19) United States
(12) Patent Application Publication
(10) Pub. No.: US 2016/0068645 A1
(43) Pub. Date: Mar. 10, 2016

(54) LATEX SPONGE

(71) Applicant: JIANGSU HEALTHCARE CO., LTD, Jiangsu (CN)

(72) Inventors: Zhanggen Ni, Jiangsu (CN); Tao Lin, Jiangsu (CN)

(73) Assignee: JIANGSU HEALTHCARE CO., LTD, Jiangsu (CN)

(21) Appl. No.: 14/943,829

(22) Filed: Nov. 17, 2015

Related U.S. Application Data
(63) Continuation of application No. PCT/CN2013/079264, filed on Jul. 12, 2013.

(30) Foreign Application Priority Data
May 17, 2013 (CN) 201310183862.8

(51) Int. Cl. C08J 9/00; C08G 18/32

(52) U.S. Cl. CPC C08J 9/0042; C08G 18/3206; C08J 2375/08

(57) ABSTRACT

A latex sponge made from a mixture containing the following materials in parts by weight: 100 pts. wt. of a polyether polyol, 35-75 pts. wt. of an isocyanate, 0.5-1.5 pts. wt. of a glycol, 0.2-0.6 pts. wt. of a catalyst, 1.2-1.3 pts. wt. of a silicone oil, and 1.5-3.5 pts. wt. of water that functions as a foaming agent. The isocyanate may be methylene diphenyl diisocyanate (MDI); the polyether polyol may be a graft polyether having a molecular weight about 4,800; and the catalyst may be triethylene diamine.

### CROSS REFERENCE TO RELATED APPLICATIONS

This is a Continuation-In-Part of PCT/CN2013/079264, filed on Jul. 12, 2013, which claims the priority of Chinese Patent Application No. CN201310183862.8, filed on May 17, 2013. This claims the priority and benefits of these prior applications and incorporates their disclosures by reference in their entirety.

### TECHNICAL FIELD

The present invention relates to a latex sponge (or foam).

### BACKGROUND ART

With the improvements in living standards, requirements for sponge are also getting higher and higher. When people select sponge (or foam), the feel of touch and elasticity are the main judging factors. The soft touch and elastic sponges are popular among consumers. Comparing with a conventional sponge, a latex sponge is a sponge with pore structures and has high elasticity and good load-carrying properties. It is comfortable and durable. At the same time, because the latex cannot be easily vacuum packed, the application and market space of latex is limited.

### SUMMARY OF THE INVENTION

An object of the present invention is to provide a latex sponge that is without pungent smell of rubber, has high density, and/or can be vacuum packed.

To solve the above technical problem, a technical solution adopted by the present invention is: A latex sponge comprises the following substances in parts by weight in a preparation process: 100 pts. wt. of polyether polyol, 35-75 pts. wt. of isocyanate, 0.5-1.5 pts. wt. of glycol, 0.2-0.6 pts. wt. of a catalyst, 1.2-1.3 pts. wt. of silicone oil, and 1.5-3.5 pts. wt. of a foaming agent (e.g., water).

In further embodiments, said polyether polyol may be a graft polyether, polyoxypropylene diol, polyoxyethylene oxypropylene triol copolymer, polyoxypropylene glyceryl ether, or a mixture of such polyether polyols. A graft polyether may be synthesized based on a reactive polyether, for example by reacting ethylene oxide and/or propylene oxide with glycerol. The polyether polyols preferably have molecular weights in a range of 1,000-10,000, more preferably 2,000-7,000, most preferably around 5,000, such as around 4,800.

The isocyanates for use in embodiments of the invention may be any suitable isocyanates known in the art for the manufacturing of sponges or foams. These isocyanates are typically aromatic diisocyanates. Examples of such isocyanates include MDI (methylene diphenyl diisocyanate) and variants thereof. MDI can exist in various isoforms, including 2,2′-MDI, 2,4′-MDI, and 4,4′-MDI depending on the positions of the attachments of the diisocyanate groups. Such isocyanates are commercially available.

In further embodiments, said catalyst may be any catalyst known in the art for the manufacturing of latex sponges, such as triethylene diamine or a mixture of triethylene diamine and stannous butyrate.

In further embodiments, said silicone oil (i.e., polymerized siloxanes with organic side chains) may be any silicone oil for soft foam manufacturing. Many silicone oils with different viscosities are commercially available (e.g., from Sigma Aldrich). See also, U.S. patent application publication No. 2013/0035409, the disclosure of which is incorporated by reference in its entirety. Any such silicone oils may be used with embodiments of the invention. An example of a silicone oil may have a formula of: CₓH₂ₓO_{y}Siₘ₊ₙ₊₂₎[C₂H₄O]ₐ[C₃H₆O]_{b} with a molecular weight around 30,000.

The manufacturing process of said latex sponge may be the same as the manufacturing process for a slow rebound sponge according to patent application of CN101709143A, the disclosure of which is incorporated by reference in its entirety. For example, a flatbed foam formation process disclosed in CN101709143A includes: spraying/injecting a mixture of the starting materials onto a conveyor belt, which is surrounded by ovens on both sides to control the temperature at 35-50° C. The width of the belt (i.e., the distance between the two ovens) controls the width of the sponges made, while the injection (spraying) speed and the belt movement speed control the thickness of the sponge made. In a typical example, the starting material mixture is injected at 150-320 Kg/min, and the foaming process may be completed in 3-5 minutes under these conditions.

The advantages of the present invention may include one or more of the following: by adjusting the raw materials and recipes for the products, latex sponges without pungent smell of rubber can be produced by adopting the manufacturing process for the manufacturing of a slow rebound sponge. At the same time, the latex cannot be vacuum packed, but the latex sponge can. The foaming density of a latex sponge of the present invention may be around 40D and the density of the end latex sponge may be at least 70D so that lots of raw materials are saved.

### DETAILED DESCRIPTION

For full understanding of the technical essence and beneficial effects of the present invention by the public, exemplary embodiments of the present invention will be described in detail. However, the description of embodiments of the applicant is not intended as a limitation of the invention. Any formal non-essential modifications or variations according to the concept of the present invention should be deemed to fall within the scope of the present invention.

In this description, any numerical range is meant to include all numbers in the range, as if each individual number has been individually disclosed. The numbers may be modified with “about” or “around,” which intends to include numbers with 20% or less variations from the number that follows, preferably 10% or less, and most preferably 5% or less.

### EXAMPLE 1

A latex sponge is prepared comprising the following substances in parts by weight in a preparation process: 65 pts. wt. of polyoxyethylene oxypropylene triol copolymer, 20 pts. wt. of a reactive polyether-based synthetic graft polyethers, 10 pts. wt. of polyoxypropylene diol, 5 pts. wt. of polyoxypropylene glyceryl ether, 57.7 pts. wt. of methylene diphenyl diisocyanate (MDI), 1 pts. wt. of glycol, 0.4 pts. wt. of triethylene diamine, 1.2 pts. wt. of silicone oil, wherein the silicon oil is polysiloxane polyether copolymer, and 2.7 pts. wt. of a foaming agent (i.e., water).

A latex sponge with density of 40D, which is soft and comfort to use, can be obtained with the above mentioned materials according to the manufacturing method for a slow rebound sponge. Any process commonly used in the art for the manufacturing of a latex sponge may be used, such as the processes disclosed in CN101709143A. The physical properties are as follows: extension percentage, 175%; tensile-strength, 51.7 kPa; degree of hardness, 8 ILD.

### EXAMPLE 2

A recipe of the latex sponge of the present invention compries the following materials in parts by weight in a preparation process: 65 pts. wt. of polyoxyethylene oxypropylene triol copolymer, 20 pts. wt. of reactive polyether of polyether-based synthetic graft polyethers, 15 pts. wt. of polyoxypropylene glyceryl ether, 49 pts. wt. of isocyanate (MDI), 1 pts. wt. of glycol, 0.4 pts. wt. of triethylene diamine, 1.3 pts. wt. of silicon oil, wherein the silicon oil is polysiloxane polyether copolymer, and 2.25 pts. wt. of foaming agent (i.e. water).

A latex sponge with density of 45D, which has the same touch feel with the latex, can be obtained with the above mentioned materials according to a manufacturing method for a slow rebound sponge. The physical properties are as follows: extension percentage, 160%; tensile-strength, 53; degree of hardness, 8 ILD.

### EXAMPLE 3

A recipe of the latex sponge of the present invention comprises the following substances in parts by weight in a preparation process: 65 pts. wt. of polyoxyethylene oxypropylene triol copolymer, 20 pts. wt. of reactive polyether-based synthetic graft polyethers, 10 pts. wt. of polyoxypropylene diol, 5 pts. wt. of polyoxypropylene glyceryl ether, 51 pts. wt. of isocyanate (MDI), 1 pts. wt. of glycol, 0.2 pts. wt. of triethylene diamine, 1.2 pts. wt. of silicone oil, wherein the silicone oil is polysiloxane polyether copolymer, and 2 pts. wt. of foaming agent (i.e., water).

A latex sponge with density of 50D, which is comfortable to touch, can be obtained with the above mentioned materials according to a manufacturing method for a slow rebound sponge. The physical properties are as follows: extension percentage, 166%; tensile-strength, 55; degree of hardness, 8 ILD.

### EXAMPLE 4

A recipe of the latex sponge of the present invention comprises the following substances in parts by weight in a preparation process: 65 pts. wt. of polyoxyethylene oxypropylene triol copolymer, 20 pts. wt. of reactive polyether of polyether-based synthetic graft polyethers, 15 pts. wt. of polyoxypropylene glyceryl ether, 62 pts. wt. of isocyanate (MDI), 1 pts. wt. of glycol, 0.6 pts. wt. of triethylene diamine, 1.3 pts. wt. of silicon oil, wherein the silicone oil is polysiloxane polyether copolymer, and 3 pts. wt. of foaming agent (i.e., water).

A latex sponge with density of 35D (D=Kg/m³) without latex touch feel, can be obtained with the above mentioned materials according to a manufacturing method for a slow rebound sponge. The physical properties are as follows: extension percentage, 150%; tensile-strength, 52; degree of hardness, 9 ILD (indentation load deflection).

Latex sponges of the present invention are essentially sponges in nature. However, they also have the characters of latex and are better than latex. Conventional latex has pungent smell and is limited by the raw material. In contrast, the latex sponges of the invention are soft and comfortable, have no smell, satisfy the paralleling requirements of sponge and latex, and can replace the sponge and latex completely.

What is claimed is:

1. A latex sponge made from a mixture comprising the following materials in parts by weight: 100 pts. wt. of a polyether polyol, 35-75 pts. wt. of an isocyanate, 0.5-1.5 pts. wt. of a glycol, 0.2-0.6 pts. wt. of a catalyst, 1.2-1.3 pts. wt. of a silicone oil, and 1.5-3.5 pts. wt. of water that functions as a foaming agent.

2. The latex sponge according to claim 1, wherein the polyether polyol is a graft polyether, polyoxypropylene diol, polyoxyethylene oxypropylene triol copolymer, polyoxypropylene glyceryl ether, or a mixture thereof.

3. The latex sponge according to claim 1, wherein the catalyst is triethylene diamine.

4. The latex sponge according to claim 1, wherein the silicone oil has a molecular weight about 30,000.

5. The latex sponge according to claim 1, wherein the isocyanate is methylene diphenyl diisocyanate (MDI).
